(19) United States
(12) Patent Application Publication
(10) Pub. No.: US 2020/0332851 A1
(43) Pub. Date: Oct. 22, 2020

(54) FRICTIONAL MEMBER, AND FRICTIONAL MATERIAL COMPOSITION AND FRICTIONAL MATERIAL FOR LOWER-LAYER MATERIAL

(71) Applicant: HITACHI CHEMICAL COMPANY, LTD., Tokyo (JP)

(72) Inventors: Yoshihisa TAKAHASHI, Chiyoda-ku, Tokyo (JP); Kazuya BABA, Chiyoda-ku, Tokyo (JP)

(73) Assignee: HITACHI CHEMICAL COMPANY, LTD., Tokyo (JP)

(21) Appl. No.: 16/755,625

(22) PCT Filed: Oct. 26, 2017
(86) PCT No.: PCT/JP2017/038772

§ 371 Date: Apr. 13, 2020

(51) Int. Cl. F16D 69/02; F16D 65/092

(52) U.S. Cl. CPC F16D 69/026; F16D 65/092; F16D 2250/00; F16D 2200/0065; F16D 2200/0078

(57) ABSTRACT

There are provided a friction member in which both shear strength at normal temperature and high temperature and crack resistance can be satisfied, the disk rotor-attacking properties are low, and the vibration damping properties are high, and brake squeal is less likely to occur, and a friction material composition for an underlay material with which the friction member is obtained, and a friction material. The friction member is more specifically a friction member comprising an overlay material, an underlay material, and a back metal in this order, wherein the underlay material comprises fibrous wollastonite, an average fiber length of the fibrous wollastonite is 100 to 850 μm, and an aspect ratio (average fiber length/average fiber diameter) of the fibrous wollastonite is 8 or more.

### TECHNICAL FIELD

The present invention relates to a friction member such as a disk brake pad used for the braking of an automobile or the like, and a friction material composition for an underlay material used for the friction member, and a friction material.

### BACKGROUND ART

Generally, brakes mounted in automobiles and the like are broadly divided mainly into two groups, disk brakes and drum brakes. In a disk brake, a disk rotor rotating integrally with a wheel during running is sandwiched between brake pads, and the friction force generated at this time generates braking force. In a drum brake, for example, brake linings (also referred to as a brake shoe) are mounted inside a drum installed inside a wheel, and by pressing the brake linings from the inside to the outside, braking force is exhibited.

Friction materials are provided in the brake pads of a disk brake and the brake linings of a drum brake, and the friction materials produce friction with facing materials such as a disk rotor and a drum to convert the kinetic energy of automobiles or the like into thermal energy for braking. Therefore, a good friction coefficient, abrasion resistance (the fact that the life of a friction material is long), strength, vibration damping properties (the fact that brake squeal is less likely to occur), and the like are required of a friction material.

In recent years, because of the improvement of required performance for a brake, a brake pad composed of two layers of friction materials is general in which a friction material having friction performance such as a friction coefficient and abrasion resistance is disposed on the sliding surface side as an “overlay material”, and a friction material having adhesive strength to a back plate and crack resistance is disposed on the back plate side as an “underlay material”.

A friction material usually comprises a bonding material, a fiber substrate, an inorganic filler, an organic filler, and the like. A method of containing metal fibers such as copper fibers, brass fibers, or iron fibers in order to improve the strength of a friction material is known (see, for example, PTL1).

But, it is suggested that with these friction materials containing copper or a copper alloy, copper is contained in a large amount in the abrasion powders generated by braking, and therefore it causes the contamination of rivers, lakes, seas, and the like. Laws limiting the amounts of copper components used in friction materials are enforced mainly in the United States, particularly California and Washington. Therefore, in order to provide a friction material that can be used in foreign countries including the United States, it is required to contain no copper or significantly reduce the content of copper, and a friction material containing copper as an essential component currently has low commercial value.

On the other hand, a method of using inorganic fibers such as whisker-like calcium silicate fibers for strength improvement is known (see, for example, PTL2).

### CITATION LIST

### Patent Literature

PTL1: JP 6-184525 A

PTL2: JP 9-316209 A

### SUMMARY OF INVENTION

### Technical Problem

However, it has become clear by the study of the present inventors that among calcium silicate fibers (also referred to as fibrous wollastonite) including the whisker-like calcium silicate fibers described in PTL2, there are those for which it is difficult to satisfy both shear strength at normal temperature and high temperature and crack resistance, and among them, those having a problem with dispersibility in a composition are included. Further, the present inventors have studied diligently, and as a result, it has become clear that when a friction material containing calcium silicate fibers (fibrous wollastonite) comes into contact with a disk rotor, the amount of abrasion of the disk rotor may increase.

Accordingly, it is an object of the present invention to provide a friction member in which both shear strength at normal temperature and high temperature and crack resistance can be satisfied, the disk rotor-attacking properties are low, and the vibration damping properties are high, and brake squeal is less likely to occur, and a friction material composition for an underlay material that can form the friction member, and a friction material.

### Solution to Problem

The present inventors have studied diligently in order to resolve the above object, and as a result found that the above object can be achieved by using, in a friction member having an overlay material, an underlay material, and a back metal in this order, an underlay material comprising a friction material composition for an underlay material containing fibrous wollastonite having a particular average fiber length and a particular aspect ratio (average fiber length/average fiber diameter), leading to the completion of the present invention. The present invention has been completed based on such findings.

The present invention relates to the following [1] to [11].
[1] A friction member comprising an overlay material, an underlay material, and a back metal in this order,

wherein the underlay material comprises fibrous wollastonite, an average fiber length of the fibrous wollastonite is 100 to 850 μm, and an aspect ratio (average fiber length/average fiber diameter) of the fibrous wollastonite is 8 or more.
[2] The friction member according to the above [1], wherein the aspect ratio (_{average} fiber length/average fiber diameter) of the fibrous wollastonite is 8 to 20.
[3] The friction member according to the above [1] or [2], wherein the underlay material further comprises at least one selected from the group consisting of an organic filler, an inorganic filler, organic fibers, and a bonding material.
[4] The friction member according to any of the above [1] to [3], wherein the underlay material further comprises inorganic fibers other than the fibrous wollastonite.
[5] The friction member according to the above [4], wherein the inorganic fibers are at least one selected from the group consisting of glass fibers, metal fibers, artificial mineral fibers, carbon fibers, ceramic fibers, biodegradable ceramic fibers, sepiolite, attapulgite, potassium titanate fibers, silica alumina fibers, and flame-resistant fibers.
[6] A friction material composition for an underlay material, the friction material comprising fibrous wollastonite, wherein an average fiber length of the fibrous wollastonite is 100 to 850 μm, and an aspect ratio (average fiber length/average fiber diameter) of the fibrous wollastonite is 8 or more.
[7] The friction material composition for an underlay material according to the above [6], wherein the aspect ratio (average fiber length/average fiber diameter) of the fibrous wollastonite is 8 to 20.
[8] The friction material composition for an underlay material according to the above [6] or [7], further comprising at least one selected from the group consisting of an organic filler, an inorganic filler, organic fibers, and a bonding material.
[9] The friction material composition for an underlay material according to any of the above [6] to [8], further comprising inorganic fibers other than the fibrous wollastonite.
[10] The friction material composition for an underlay material according to the above [9], wherein the inorganic fibers are at least one selected from the group consisting of glass fibers, metal fibers, artificial mineral fibers, carbon fibers, ceramic fibers, biodegradable ceramic fibers, sepiolite, attapulgite, potassium titanate fibers, silica alumina fibers, and flame-resistant fibers.
[11] A friction material comprising an underlay material obtained by molding the friction material composition for an underlay material according to any of the above [6] to [10].

### Advantageous Effects of Invention

It is possible to provide a friction member in which both shear strength at normal temperature and high temperature and crack resistance can be satisfied, the disk rotor-attacking properties are low, and the vibration damping properties are high, and brake squeal is less likely to occur, and a friction material composition for an underlay material that can form the friction member, and a friction material.

### BRIEF DESCRIPTION OF DRAWING

FIG. 1 is a schematic diagram showing one form of the friction member of the present invention.

### DESCRIPTION OF EMBODIMENTS

The present invention will be described in detail below. However, in the following embodiments, their components are not essential unless otherwise specified. The same applies to numerical values and their ranges, and they do not limit the present invention.

For a numerical value range described herein, the upper limit value or lower limit value of the numerical value range may be replaced by a value shown in Examples. Further, as used herein, the content of each component in a friction material composition means, when a plurality of substances corresponding to each component are present, the total content of the plurality of substances present in the friction material composition unless otherwise noted.

Forms in which matters described herein are arbitrarily combined are also included in the present invention.

The present invention is a friction member having an overlay material, an underlay material, and a back metal in this order,

in which the underlay material contains fibrous wollastonite, the average fiber length of the fibrous wollastonite is 100 to 850 μm, and the aspect ratio (average fiber length/average fiber diameter) of the fibrous wollastonite is 8 or more.

The material used for the underlay material (hereinafter referred to as a friction material composition for an underlay material) will be described in detail below. The components that the “friction material composition for an underlay material” can contain are the components that the “underlay material” can contain.

### [Friction Material Composition for Underlay Material]

The friction material composition for an underlay material used in the present invention contains fibrous wollastonite, the average fiber length of the fibrous wollastonite is 100 to 850 μm, and the aspect ratio (average fiber length/average fiber diameter) of the fibrous wollastonite is 8 or more.

A preferred form of the friction material composition for an underlay material used in the present invention is a friction material composition for an underlay material further containing, together with the fibrous wollastonite, at least one selected from the group consisting of an organic filler, an inorganic filler, organic fibers, and a bonding material, and a more preferred form is a friction material composition for an underlay material further containing, together with the fibrous wollastonite, an organic filler, an inorganic filler, organic fibers, and a bonding material. A form in which the friction material composition for an underlay material further contains inorganic fibers other than the fibrous wollastonite, as described later is also preferred.

The friction material composition for an underlay material may comprise no copper, or have a content of copper of less than 0.5% by mass in terms of a copper element even if comprising copper, and preferably does so.

The friction material composition for an underlay material used in the present invention preferably contains no copper though not particularly limited. In a case where the friction material composition for an underlay material comprises copper, by setting the content of copper in the friction material composition for an underlay material at less than 0.5% by mass in terms of a copper element, the friction material composition for an underlay material can be one causing no contamination of rivers and the like even if released into the environment as an abrasion powder. The content of copper represents the content of the copper element (Cu) contained in copper, a copper alloy, and a copper compound in fibrous and powdery forms and the like, in the entire friction material composition for an underlay material.

The content of copper in the friction material composition for an underlay material is more preferably 0.2% by mass or less, further preferably 0.05% by mass or less, in terms of a copper element.

When an iron-based metal such as iron fibers is removed from an underlay material, problems such as durability decrease due to rusting at an adhesion interface with a back metal tend not to occur. Therefore, an attempt has also been made to use no metal fibers and use inorganic fibers instead, but in this case, it has become clear that toughness like that of metal fibers is not obtained, and the problem of a decrease in shear strength at normal temperature or high temperature, and problems such as a decrease in crack resistance can occur anew. Here, the iron-based metal is a metal comprising iron as a main component, and refers to general iron and steel, and the content of iron represents the content of the iron element (Fe) contained in iron, an iron alloy, and an iron compound, in the entire friction material composition for an underlay material.

Accordingly, from the viewpoint of avoiding durability decrease due to rusting, and the like, the friction material composition for an underlay material used in the present invention preferably contains no iron-based metal. Even in a case where the friction material composition for an underlay material comprises an iron-based metal, by setting the content of the iron-based metal in the friction material composition for an underlay material at less than 0.5% by mass in terms of an iron element, the rust resistance can be made good, and durability decrease due to rusting at an adhesion interface with a back metal can be suppressed. In the present invention, the toughness is sufficient, the shear strength at normal temperature or high temperature is also high, and the crack resistance is also good, even if the content of the iron-based metal is controlled in the range. The content of the iron-based metal in the friction material composition for an underlay material is more preferably 0.2% by mass or less, further preferably 0.05% by mass or less, in terms of an iron element.

The friction material composition for an underlay material used in the present invention is classified into a NAO (Non-Asbestos-Organic) material and is the so-called non-asbestos friction material composition (a friction material composition containing no asbestos, or a friction material composition having an extremely slight content of asbestos even when containing asbestos). In the friction material composition for an underlay material, the content of asbestos is 0.2% by mass or less, substantially 0% by mass.

The components that the friction material composition for an underlay material may contain will be described in order below.

### (Organic Filler)

The organic filler can exhibit a function as a friction-adjusting agent for improving vibration damping properties, abrasion resistance, and the like. Here, in the present invention, the organic filler does not include one having a fibrous shape (for example, the organic fibers described later). One organic filler may be used alone, or two or more organic fillers may be used in combination.

As the organic filler, organic fillers generally used in friction material compositions can be used. Examples thereof include cashew particles, rubbers, and melamine particles. Among these, cashew particles and rubbers are preferred from the viewpoint of making the stability of the friction coefficient, and the abrasion resistance good and the viewpoint of suppressing squeal.

As the organic filler, cashew particles and a rubber may be used in combination, or cashew particles coated with a rubber may be used.

The cashew particles are obtained by pulverizing a cured product of cashew nutshell oil, and are also generally referred to as cashew dust.

Cashew particles are generally classified into a brown type, a brown-black type, a black type, and the like according to the type of the curing agent used for the curing reaction. For the cashew particles, by adjusting the molecular weight and the like, the heat resistance and the sound and vibration properties and further the film forming properties on a rotor that is the opposite material, and the like can be easily controlled.

The average particle diameter of the cashew particles is preferably 850 μm or less, more preferably 750 μm or less, and further preferably 600 μm or less from the viewpoint of dispersibility. The lower limit value of the average particle diameter of the cashew particles is not particularly limited and may be 200 μm or more, 300 μm or more, or 400 μm or more. As used herein, average particle diameter means the value of d50 (the median diameter, cumulative median, of volume distribution) measured using a method of laser diffraction particle size distribution measurement. The same applies below. For example, average particle diameter can be measured by a laser diffraction/scattering particle diameter distribution measuring apparatus, trade name: LA.920 (manufactured by HORIBA, Ltd.).

As the cashew particles, commercial products can be used.

One type of cashew particles may be used alone, or two or more types of cashew particles may be used in combination.

When the friction material composition for an underlay material contains the organic filler, its content is preferably 1 to 20 parts by mass, more preferably 1 to 10 parts by mass, further preferably 1 to 8 parts by mass, and particularly preferably 1 to 5 parts by mass based on 100 parts by mass of the friction material composition for an underlay material. By setting the total content of the organic filler in the above ranges, an increase in the elastic modulus of a friction material, and the deterioration of the vibration damping properties, such as squeal, and the deterioration of the abrasion resistance tend to be avoided, and the deterioration of the heat resistance, and the strength decrease due to the thermal history tend to be avoided.

Examples of the rubbers include rubbers usually used in friction material compositions. Examples thereof include natural rubbers and synthetic rubbers. Examples of the synthetic rubbers include acrylonitrile-butadiene rubbers (NBR), acrylic rubbers, isoprene rubbers, polybutadiene rubbers (BR), styrene butadiene rubbers (SBR), silicone rubbers, and pulverized powders of tire tread rubbers. Among these, acrylonitrile-butadiene rubbers (NBR) and pulverized powders of tire tread rubbers are preferred from the viewpoint of the balance of heat resistance, flexibility, and production cost. When the rubber is contained, its content is preferably 1 to 30 parts by mass, more preferably 2 to 15 parts by mass, in the friction material composition. By setting the content of the rubber in the above ranges, an increase in the elastic modulus of the friction material, and the deterioration of the vibration damping properties, such as squeal, tend to be avoided, and the deterioration of the heat resistance, and the strength decrease due to the thermal history tend to be avoided.

### (Inorganic Filler)

The inorganic filler can exhibit a function as a friction-adjusting material for avoiding the deterioration of the heat resistance, the abrasion resistance, the stability of the friction coefficient, and the like of the friction material. Here, in the present invention, the inorganic filler does not include one having a fibrous shape (for example, the inorganic fibers described later). One inorganic filler may be used alone, or two or more inorganic fillers may be used in combination.

The inorganic filler is not particularly limited and may be an inorganic filler usually used in a friction material. Examples of the inorganic filler include metal sulfides such as antimony trisulfide, tin sulfide, molybdenum disulfide, bismuth sulfide, and zinc sulfide; titanates such as potassium titanate, lithium potassium titanate, sodium titanate, and magnesium potassium titanate; mica, graphite, coke, calcium hydroxide, calcium oxide, sodium carbonate, calcium carbonate, magnesium carbonate, barium sulfate, dolomite, coke, mica, vermiculite, calcium sulfate, granular potassium titanate, plate-like potassium titanate, talc, clay, zeolite, zirconium silicate, zirconia, mullite, chromite, titanium oxide, magnesium oxide, silica, triiron tetroxide, zinc oxide, garnet, α-alumina, γ-alumina, and silicon carbide; and metal powders such as iron powders, cast iron powders, aluminum powders, nickel powders, tin powders, zinc powders, and alloy powders containing at least one of the metals. Although not particularly limited, as the inorganic filler, those containing no copper or iron-based metal are preferred. Among these, at least one selected from the group consisting of metal sulfides, titanates, mica, graphite, calcium hydroxide, barium sulfate, and zirconia is preferred, at least one selected from the group consisting of graphite, calcium hydroxide, and barium sulfate is more preferred, and it is more preferred to use graphite, calcium hydroxide, and barium sulfate in combination.

Among the above inorganic fillers, calcium hydroxide, calcium oxide, sodium carbonate, and zinc oxide are preferred from the viewpoint of suppressing rust formation on the friction material. However, calcium hydroxide, calcium oxide, or sodium carbonate increases the pH of the friction material, and the aramid fibers tend to decompose easily. Therefore, when calcium hydroxide, calcium oxide, or sodium carbonate is used, attention is preferably paid to the amount of calcium hydroxide, calcium oxide, or sodium carbonate used, so that the pH is not too high. For example, when calcium hydroxide is contained as the inorganic filler, the content of calcium hydroxide is preferably 0.5 to 10 parts by mass, more preferably 1 to 8 parts by mass, and further preferably 1 to 5 parts by mass based on 100 parts by mass of the friction material composition for an underlay material.

The graphite is not particularly limited, and known graphite, in other words, both natural graphite and artificial graphite, can be used. The graphite preferably has an average particle diameter of 1 to 50 μm, more preferably 2 to 40 μm, further preferably 5 to 30 μm, and particularly preferably 10 to 20 μm. When the average particle diameter of the graphite is 1 μm or more, an excess increase in the thermal conductivity of the underlay material is suppressed, and frictional heat being transferred to the back plate side to cause vapor lock is easily suppressed. When the average particle diameter of the graphite is 20 μm or less, the thermal conductivity of the underlay material tends to improve, the curing of the bonding material during molding tends to be promoted, and excellent strength tends to be exhibited. Graphite in which the average particle diameter is outside the ranges may be used.

When the friction material composition for an underlay material contains graphite, its content is preferably 2 to 20 parts by mass, more preferably 3 to 15 parts by mass, and further preferably 5 to 15 parts by mass based on 100 parts by mass of the friction material composition for an underlay material. The upper limit value of the content of graphite may be 10 parts by mass. When the content of graphite is 2 parts by mass or more, the thermal conductivity of the underlay material is easily improved. When the content of graphite is 20 parts by mass or less, an excess increase in the thermal conductivity of the underlay material is suppressed, and a decrease in the friction coefficient is easily suppressed.

When the friction material composition for an underlay material contains barium sulfate, its content is preferably 20 to 70 parts by mass, more preferably 20 to 60 parts by mass, and further preferably 30 to 60 parts by mass based on 100 parts by mass of the friction material composition for an underlay material. The upper limit value of the content of barium sulfate may be 55 parts by mass or 50 parts by mass. When the content of barium sulfate is 20 parts by mass or more, the bulk density of the friction material composition for an underlay material increases, and the handling properties are good. When the content of barium sulfate is 70 parts by mass or less, decreases in the shear strength and crack resistance of a friction material for an underlay material can be avoided.

When the friction material composition for an underlay material contains the inorganic filler, its content is preferably 20 to 75 parts by mass, more preferably 30 to 70 parts by mass, further preferably 40 to 65 parts by mass, and particularly preferably 40 to 60 parts by mass based on 100 parts by mass of the friction material composition for an underlay material. By setting the content of the inorganic filler in the above ranges, the deterioration of the heat resistance is easily avoided. The upper limit value of the content of the inorganic filler may be 55 parts by mass.

### (Fiber Substrate; Organic Fibers and Inorganic Fibers)

The fiber substrate exhibits a reinforcing action in the friction material. The friction material composition for an underlay material preferably contains organic fibers, in addition to the particular fibrous wollastonite (inorganic fibers), as the fiber substrate, and preferably also contains inorganic fibers other than the particular fibrous wollastonite. One fiber substrate may be used alone, or two or more fiber substrates may be used in combination. The inorganic fibers can exhibit the effect of improving the mechanical strength and abrasion resistance of the friction material. The organic fibers are a fibrous material comprising organic matter as a main component. The inorganic fibers are a fibrous material comprising inorganic matter other than a metal and a metal alloy as a main component.

### —Organic Fibers—

Examples of the organic fibers include hemp, cotton, aramid fibers, cellulose fibers, acrylic fibers, and phenolic resin fibers (having a crosslinked structure). One type of organic fibers may be used alone, or two or more types of organic fibers may be used in combination. As the organic fibers, aramid fibers are preferred from the viewpoint of heat resistance. From the viewpoint of improving the strength of the friction material, as the organic fibers, fibrillated organic fibers are preferably contained, and fibrillated aramid fibers are more preferably contained. The fibrillated organic fibers are divided and fluffy organic fibers, and fibrillated aramid fibers, fibrillated acrylic fibers, fibrillated cellulose fibers, and the like are commercially available. Needless to say, the friction material composition for an underlay material may contain other organic fibers together with fibrillated organic fibers.

When the friction material composition for an underlay material contains organic fibers, particularly fibrillated organic fibers, their content is preferably 1 to 8 parts by mass, more preferably 2 to 7 parts by mass, and further preferably 1 to 5 parts by mass based on 100 parts by mass of the friction material composition for an underlay material. When the content is 1 part by mass or more, good shear strength, crack resistance, and abrasion resistance tend to be exhibited. When the content is 8 parts by mass or less, the deterioration of the shear strength and the crack resistance due to the uneven distribution of the organic fibers (fibrillated organic fibers) and other materials in the friction material composition for an underlay material can be effectively suppressed.

### —Inorganic Fibers—

In the present invention, as the inorganic fibers, at least the following particular fibrous wollastonite is contained.

Fibrous wollastonite refers to a naturally produced silicate mineral comprising CaSiO₃ as a main component that is pulverized and classified, and processed into a fibrous form.

The average fiber length of the fibrous wollastonite used in the present invention is 100 to 850 μm, preferably 130 to 850 μm, from the viewpoint of providing strength to the friction material and the viewpoint of the dispersibility in the friction material composition for an underlay material. By setting the average fiber length of the fibrous wollastonite at 100 to 850 μm, the dispersibility of the fibrous wollastonite is good in the process of mixing the friction material composition for an underlay material, and the shear strength at normal temperature and high temperature and crack resistance of the underlay material can be effectively improved.

The average fiber diameter of the fibrous wollastonite is preferably 70 μm or less, more preferably 60 μm or less, from the viewpoint of providing strength to the friction material. The lower limit value of the average fiber diameter is not particularly limited but is preferably 5 μm or more, more preferably 8 μm or more.

As used herein, average fiber length and average fiber diameter respectively represent the average values obtained by selecting 50 inorganic fibers used, at random, and measuring the fiber length and the fiber diameter by an optical microscope, but in the case of a commercial product, catalog values can be referred to. As used herein, fiber diameter refers to the diameter of a fiber.

The average aspect ratio (average fiber length/average fiber diameter) of the fibrous wollastonite used in the present invention is 8 or more, preferably 8 to 20, more preferably 9 to 20, further preferably 10 to 18, and particularly preferably 12 to 17. By setting the average aspect ratio at 8 or more, the shear strength at normal temperature and high temperature and crack resistance of the friction material can be effectively improved.

In order to increase the affinity for the bonding material, the surface of the fibrous wollastonite may be treated with an aminosilane, an epoxysilane, or the like.

The content of the fibrous wollastonite in the friction material composition for an underlay material is preferably 3 to 30 parts by mass, more preferably 5 to 30 parts by mass, and further preferably 5 to 20 parts by mass based on 100 parts by mass of the friction material composition for an underlay material. When the content of the fibrous wollastonite is 3 parts by mass or more, the fibrous wollastonite is well dispersed in the friction material, and the strength of the friction material improves. When the content of the fibrous wollastonite is 30 parts by mass or less, the deterioration of the shear strength and the crack resistance due to the uneven distribution of the fibrous wollastonite and other materials in the friction material composition for an underlay material can be effectively suppressed.

One of the particular fibrous wollastonite may be used alone, or two or more of the particular fibrous wollastonites may be used in combination. Fibrous wollastonite other than the particular fibrous wollastonite may be used in combination in a range that does not impair the effects of the present invention.

As the inorganic fibers, inorganic fibers other than the fibrous wollastonite can be used in combination. As the inorganic fibers, for example, at least one selected from the group consisting of glass fibers, metal fibers, artificial mineral fibers, carbon fibers, ceramic fibers, biodegradable ceramic fibers, sepiolite (α-type sepiolite and β-type sepiolite), attapulgite, potassium titanate fibers, silica alumina fibers, flame-resistant fibers, and the like can be used. Particularly, a form in which at least glass fibers are contained as the inorganic fibers is preferred.

The glass fibers refer to fibers produced by melting and spinning glass. For the glass fibers, those whose raw materials are E glass, C glass, S glass, D glass, and the like can be used, and among these, glass fibers containing E glass or S glass are preferably used from the viewpoint of particularly high strength. For the improvement of the affinity for the bonding material, glass fibers in which the surfaces of the glass fibers are treated with an aminosilane, an epoxysilane, or the like are preferred. From the viewpoint of improving the handling properties of the raw material and the friction material composition for an underlay material, glass fibers bundled with a urethane resin, an acrylic resin, a phenolic resin, or the like can be used, and the number of bundled fibers is preferably 50 to 1,000, and more preferably 50 to 500 from the viewpoint of the balance of dispersibility and handling properties.

The average fiber length of the glass fibers is not particularly limited but is preferably 80 to 6,000 μm, more preferably 150 to 5,000 μm, further preferably 300 to 5,000 μm, particularly preferably 1,000 to 5,000 μm, and most preferably 2,000 to 4,000 μm. When the average fiber length is 80 μm or more, the strength of the underlay material tends to improve. When the average fiber length is 6,000 μm or less, a decrease in dispersibility tends to be suppressed. The average fiber diameter of the glass fibers is preferably 5 to 20 μm, more preferably 7 to 15 μm. When the average fiber diameter is 5 μm or more, the breakage of the glass fibers during the mixing of the friction material composition for an underlay material can be suppressed. When the average fiber diameter is 20 μm or less, the strength of the underlay material tends to improve.

The content of the glass fibers in the friction material composition for an underlay material is preferably 0 to 15 parts by mass, more preferably 0 to 12 parts by mass, based on 100 parts by mass of the friction material composition for an underlay material. The lower limit value of the content may be 0.1 parts by mass, 0.5 parts by mass, or 1 part by mass. By setting the content of the glass fibers in these ranges, toughness can be provided without impairing the handling properties of the friction material composition for an underlay material after mixing, and the strength of the friction material tends to be easily improved.

Examples of the metal fibers include fibers in the form of a metal simple substance or alloy of aluminum, iron, zinc, tin, titanium, nickel, magnesium, or the like, and fibers comprising a metal such as cast iron as a main component. Examples of the fibers in the form of an alloy (alloy fibers) include iron alloy fibers and aluminum alloy fibers. One type of metal fibers may be used alone, or two or more types of metal fibers may be used in combination. In the present invention, the friction material composition for an underlay material may be a friction material composition for an underlay material containing no metal fibers.

From the viewpoint of improving the crack resistance and the abrasion resistance, generally, copper fibers, copper alloy fibers, iron fibers, and iron alloy fibers are preferred.

But, for the above-described reason, when fibers of copper or a copper alloy are contained, the content of copper in the friction material composition for an underlay material is preferably less than 0.5% by mass, more preferably 0.3% by mass or less, and further preferably 0.1% by mass or less in terms of a copper element, and particularly preferably, the friction material composition for an underlay material comprises substantially no copper. Examples of the copper alloy fibers include copper fibers, brass fibers, and bronze fibers.

From the viewpoint of suppressing durability decrease due to rusting at an adhesion interface with a back metal, when iron fibers or iron alloy fibers are contained, the content of iron in the friction material composition for an underlay material is preferably less than 0.5% by mass, more preferably 0.3% by mass or less, and further preferably 0.1% by mass or less in terms of an iron element, and particularly preferably, the friction material composition for an underlay material comprises substantially no iron.

The artificial mineral fibers are artificial inorganic fibers obtained by melt spinning using blast furnace slag such as slag wool, basalt such as basalt fibers, another natural rock, or the like as a main component. Examples of the artificial mineral fibers include artificial mineral fibers containing SiO₂, Al₂O₃, CaO, MgO, FeO, Na₂O, or the like, or artificial mineral fibers containing one or two or more of these compounds. As the artificial mineral fibers, artificial mineral fibers comprising an aluminum element are preferred, artificial mineral fibers containing Al₂O₃ are more preferred, and artificial mineral fibers containing Al₂O₃ and SiO₂ are further preferred.

The shear strength tends to decrease as the average fiber length of the artificial mineral fibers contained in the friction material composition for an underlay material increases. Therefore, the average fiber length of the artificial mineral fibers is preferably 500 μm or less, more preferably 100 to 400 μm, and further preferably 120 to 340 μm. The average fiber diameter of the artificial mineral fibers is not particularly limited but is usually 1 to 20 μm and may be 2 to 15 μm.

The artificial mineral fibers are preferably biosoluble from the viewpoint of harmfulness to the human body. The biosoluble artificial mineral fibers here are artificial mineral fibers characterized by being partially decomposed and eliminated from the body in a short time even when taken into the human body. Specifically, the biosoluble artificial mineral fibers refers to fibers in which for the chemical composition, the total amount of alkali oxides and alkaline earth oxides (the total amount of oxides of sodium, potassium, calcium, magnesium, and barium) is 18% by mass or more and which satisfy any of the following: (a) the half-life of fibers having a length of more than 20 μm is less than 10 days in a biopersistence test by short-term inhalation exposure; (b) the half-life of fibers having a length of more than 20 μm is less than 40 days in a biopersistence test by short-term intratracheal instillation; (c) there is no significant carcinogenicity in an intraperitoneal administration test; or (d) there are no carcinogenicity-related pathological findings or tumorigenesis in a long-term inhalation exposure test (see Nota Q of EU Directive 97/69/EC (carcinogenicity exemption)). Examples of such biodegradable artificial mineral fibers include SiO₂—Al₂O₃—CaO—MgO—FeO(—K₂O—Na₂O)-based fibers and include artificial mineral fibers containing, in any combination, at least two selected from SiO₂, Al₂O₃, CaO, MgO, FeO, K₂O, Na₂O, and the like.

Examples of the carbon fibers include flame-resistant fibers, pitch-based carbon fibers, PAN-based carbon fibers, and activated carbon fibers. One type of carbon fibers may be used alone, or two or more types of carbon fibers may be used in combination. The average fiber length of the carbon fibers is not particularly limited but is preferably 0.1 to 6.0 mm, more preferably 0.1 to 3.0 mm. When the average fiber length is in the ranges, the friction material is less likely to chip, and the strength is easily maintained. The average fiber diameter of the carbon fibers is not particularly limited but is preferably 5 to 20 μm.

When the friction material composition for an underlay material contains the fiber substrate, its content is preferably 5 to 50 parts by mass, more preferably 10 to 40 parts by mass, and further preferably 15 to 40 parts by mass based on 100 parts by mass of the friction material composition for an underlay material. By setting the content of the fiber substrate in the above ranges, optimal porosity as the friction material tends to be obtained, squeal tends to be prevented, appropriate material strength tends to be obtained, the abrasion resistance tends to be improved, and further the moldability tends to be improved.

### (Bonding Material)

The bonding material has the function of bonding and integrating the organic filler, the inorganic filler, the fiber substrate, and the like to provide a predetermined shape and strength. The bonding material contained in the friction material composition for an underlay material is not particularly limited, and thermosetting resins generally used as the bonding materials of friction materials can be used.

Examples of the thermosetting resins include phenolic resins, modified phenolic resins, elastomer-dispersed phenolic resins, epoxy resins, polyimide resins, and melamine resins. Here, examples of the modified phenolic resins include acrylic-modified phenolic resins, silicone-modified phenolic resins, cashew-modified phenolic resins, epoxy-modified phenolic resins, and alkylbenzene-modified phenolic resins. Examples of the elastomer-dispersed phenolic resins include acrylic elastomer-dispersed phenolic resins and silicone elastomer-dispersed phenolic resins.

Particularly, phenolic resins, acrylic-modified phenolic resins, silicone-modified phenolic resins, and alkylbenzene-modified phenolic resins are preferred, and phenolic resins are more preferred, because good heat resistance, good moldability, and a good friction coefficient are provided.

One thermosetting resin may be used alone, or two or more thermosetting resins may be used in combination.

When the friction material composition for an underlay material contains the bonding material, its content is preferably 5 to 25 parts by mass, more preferably 5 to 20 parts by mass, further preferably 6 to 18 parts by mass, and particularly preferably 8 to 16 parts by mass based on 100 parts by mass of the friction material composition for an underlay material. By setting the content of the bonding material in the above ranges, the strength of the friction material tends to be maintained, and the deterioration of the vibration damping properties, such as squeal, due to an increase in the elastic modulus tends to be more easily suppressed.

### (Other Materials)

In addition to the organic filler, the inorganic filler, the fiber substrate, and the bonding material, other materials can be blended into the friction material composition for an underlay material as needed.

Examples of other materials include metal powders such as zinc powders and aluminum; and organic additives such as fluorine-based polymers such as polytetrafluoroethylene (PTFE), from the viewpoint of improving the abrasion resistance and the thermal fade properties.

When the friction material composition for an underlay material contains the above other materials, the content of each of the above other materials is preferably 20 parts by mass or less, more preferably 10 parts by mass or less, further preferably 5 parts by mass or less, and particularly preferably 3 parts by mass or less based on 100 parts by mass of the total amount of the organic filler, the inorganic filler, the fiber substrate, and the bonding material. The friction material composition for an underlay material need not contain other materials.

### [Friction Material]

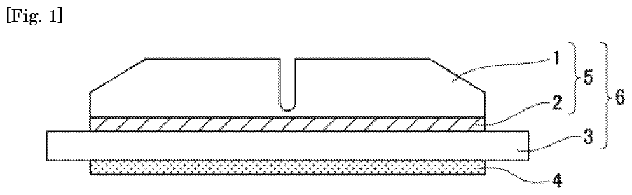

In the present invention, a friction material containing an underlay material obtained by molding the friction material composition for an underlay material is also provided. More specifically, a friction material is obtained by molding a friction material composition for an overlay material and the friction material composition for an underlay material by a generally used method, preferably hot press molding. A description will be given using FIG. 1. A part containing an overlay material 1 and an underlay material 2 corresponds to a friction material 5.

As the friction material composition for an overlay material, known friction material compositions, particularly friction material compositions for overlay materials, can be used, and the friction material composition for an overlay material is not particularly limited. As the friction material composition for an overlay material, specifically, a friction material composition for an overlay material containing an organic filler, an inorganic filler, a fiber substrate, and a bonding material is preferred, and the friction material composition for an overlay material comprising no copper, or having a content of copper of less than 0.5% by mass in terms of a copper element even if comprising the copper is more preferably used. The friction material composition for an overlay material preferably contains no fibrous wollastonite. Even if the friction material composition for an overlay material contains fibrous wollastonite, its content is preferably 2% by mass or less, more preferably 1% by mass or less, and further preferably 0.1% by mass or less in the friction material composition for an overlay material, and particularly preferably, the friction material composition for an overlay material contains substantially no fibrous wollastonite. For the organic filler, the inorganic filler, the fiber substrate, and the bonding material, the same as those described for the friction material composition for an underlay material can be used.

When viewed in the perpendicular direction from the friction surface, the proportion of the thickness of the underlay material to the thickness of the entire friction material is preferably 3 to 70%, more preferably 5 to 60%, and further preferably 6 to 50%.

The friction material is produced by separately mixing each of the friction material composition for an overlay material and the friction material composition for an underlay material using a mixing machine such as a Loedige mixer (“Loedige” is a registered trademark), a pressure kneader, or an EIRICH mixer (“EIRICH” is a registered trademark), integrally premolding the mixture for an overlay material and the mixture for an underlay material in a molding die, then molding the obtained premolded material, for example, under the conditions of a molding temperature of 130 to 160° C. and a molding pressure of 20 to 50 MPa for 2 to 10 minutes, and heat-treating the obtained molded material, for example, at 150 to 250° C. for 2 to 10 hours. Painting, scorching treatment, and polishing treatment may be performed as needed. Among the above steps, the premolding step may be omitted to directly thermally mold the mixtures.

The friction material can be used as a friction material for a disk brake pad of an automobile or the like, or a friction material for a brake lining of an automobile or the like. The friction material composition for an overlay material and the friction material composition for an underlay material can also be used as a friction material for a clutch facing, an electromagnetic brake, a holding brake, or the like by subjecting the friction material composition for an overlay material and the friction material composition for an underlay material to steps such as molding into an intended shape, processing, and affixation.

The friction material is preferred particularly as an automobile friction material because its underlay material has high vibration damping properties (large compression strain) and can satisfy both shear strength at normal temperature and high temperature and crack resistance.

### [Friction Member]

A description will be given with reference to FIG. 1. The friction material composition for an underlay material used in the present invention has high shear strength and high crack resistance and therefore is used as the underlay material 2 of a friction member. Here, the overlay material 1 is a friction material forming the friction surface of the friction member, and the underlay material 2 is a layer interposed between the overlay material 1 and a back metal 3 and intended to improve the shear strength around the adhesion portion between the friction material and the back metal and the crack resistance.

Specifically, the present invention provides a friction member 6 having the overlay material 1, the back metal 3, and the underlay material 2 obtained by molding the friction material composition for an underlay material, between the overlay material 1 and the back metal 3.

The friction member of the present invention is a friction member formed so that the overlay material of the friction material forms a friction surface, by using the friction material, in other words, a friction member in which an underlay material is located on the side opposite to a friction surface. The friction member of the present invention is not limited to the above form. Examples of the friction member of the present invention also include the friction member 6 having a shim 4 on the back metal 3 on the side opposite to the side having the underlay material 2. The shim 4 is a spacer generally used for the improvement of the vibration damping properties of a friction member.

The back metal is one usually used in a friction member for the improvement of the mechanical strength of the friction member, and as the material, metals, fiber-reinforced plastics, or the like can be used. Examples of the back metal include iron, stainless steel, inorganic fiber-reinforced plastics, and carbon fiber-reinforced plastics. The primer layer and the adhesive layer should be those usually used for friction members such as a brake pad and a brake lining.

### EXAMPLES

The present invention will be described in more detail below by Examples, but the present invention is not limited in any way by these examples.

The friction material samples of the Examples and Comparative Examples were evaluated according to the following evaluation methods.

### [Evaluation Methods]

### (1) Presence or Absence of Aggregate

A mixture for an underlay material after mixing was observed by an SEM to observe the presence or absence of an aggregate of fibrous wollastonite in 1 mm². A case where a fibrous wollastonite aggregate of 100 μm or more was confirmed was evaluated as an aggregate being “present”, and a case where no fibrous wollastonite aggregate of 100 μm or more was confirmed was evaluated as an aggregate being “absent”.

### (2) Evaluation of Vibration Damping Properties

The amount of compression strain at 160 bar (16 MPa) was measured in accordance with JIS D4413 (2005) as an indicator of vibration damping properties. As the compression strain increases, the vibration damping properties increase, and brake squeal is less likely to occur.

### (3) Measurement of Shear Strength

Shear strength at normal temperature (20° C.) and high temperature (300° C.) was measured in accordance with JIS D4422 (2007). The shear strength at high temperature was measured by performing a shear test within 1 minute after heating a disk brake pad at 300° C. for 1 hour.

### (4) Evaluation of Crack Resistance

Braking at a brake temperature of 400° C. (initial speed: 50 km/h, final speed: 0 km/h, deceleration: 0.3 G, brake temperature before braking: 100° C.) shown in JASO C427 “Automobile-Brake lining and disc brake pad-Wear test procedure on inertia dynamometer” was repeated until the thickness of a friction material halved. The formation of cracks in the friction surface and underlay material side surface of the friction material was measured, and evaluated according to the following evaluation criteria:
A: No crack formed.
B: A crack formed in the friction surface or underlay material side surface of the friction material to the extent that a thickness gauge of 0.1 mm did not enter.
C: A crack formed in the friction surface or underlay material side surface of the friction material to the extent that a thickness gauge of 0.1 mm entered.

When a crack forms in one of the friction surface and underlay material side surface of the friction material to the extent that the thickness gauge does not enter, and a crack forms in the other to the extent that the thickness gauge enters, the evaluation is C.

### (5) Evaluation of Disk Rotor-Attacking Properties

A general effectiveness test was carried out in accordance with “JASO C406”, a standard by the Society of Automotive Engineers of Japan, Inc. The thickness of a disk rotor before and after the test was measured, and from the difference in the thickness of the disk rotor before and after the test, the amount of abrasion was measured as an indicator of disk rotor-attacking properties. It is shown that as the amount of abrasion decreases, the disk rotor-attacking properties decrease, and the friction performance is better.

The above evaluation of crack resistance and disk rotor-attacking properties was performed at an inertia of 7 kgf·m·s² using a dynamometer. It was carried out using a ventilated disk rotor (manufactured by KIRIU CORPORATION, material: FC190) and a general pin-sliding collet type caliper.

### [Fabrication of Disk Brake Pads]

In the fabrication of disk brake pads, the following components of friction material compositions were provided. The components described in Table 1 and Table 2 are the same as the following:

### (Bonding Material)

Phenolic resin

### (Organic Fillers)

Cashew particles
Pulverized powder of tire tread rubber

### (Inorganic Fillers)

Potassium titanate
Zirconia
Mica
Tin sulfide
Barium sulfate
Calcium hydroxide
Graphite

### (Fiber Substrates)

Aramid fibers (organic fibers): fibrillated aramid fibers

### (Inorganic Fibers)

Artificial mineral fibers: average fiber length: 150 μm
Glass fibers: fiber length: 3,000 μm, fiber diameter: 10 μm, number of bundled fibers: 200
Fibrous wollastonite A: average fiber length: 150 μm, average fiber diameter: 12 μm, average aspect ratio: 13
Fibrous wollastonite B: average fiber length: 825 μm, average fiber diameter: 55 μm, average aspect ratio: 15
Fibrous wollastonite C: average fiber length: 13 μm, average fiber diameter: 1 μm, average aspect ratio: 13
Fibrous wollastonite D: average fiber length: 35 μm, average fiber diameter: 7 μm, average aspect ratio: 5

### Examples 1 to 4 and Comparative Examples 1 to 5

### Fabrication of Disk Brake Pads

Components were blended according to the amounts blended shown in Table 1 to obtain a friction material composition for an overlay material. Components were blended according to amounts blended shown in Table 2 to obtain a friction material composition for an underlay material.

These friction material composition for an overlay material and friction material composition for an underlay material were each separately mixed by a Loedige mixer (manufactured by MATSUBO Corporation, trade name: Loedige Mixer M20) to obtain a mixture for an overlay material and a mixture for an underlay material. The obtained mixture for an overlay material and mixture for an underlay material were integrally premolded by a molding press (manufactured by Oji Machine Co., Ltd.) (However, in Comparative Example 1, an aggregate formed in the friction material composition for an underlay material, and therefore the premolding and subsequent operations were not performed. In Comparative Example 4, only the mixture for an overlay material was premolded, and in Comparative Example 5, only the mixture for an underlay material was premolded.). The obtained premolded material was hot press-molded together with an iron back metal (manufactured by Hitachi Automotive Systems, Ltd.) under the conditions of a molding temperature of 140 to 160° C., a molding pressure of 30 MPa, and a molding time of 5 minutes using a molding press (manufactured by SANKI SEIKO CO., LTD.). The obtained molded article was heat-treated at 200° C. for 4.5 hours, polished using a rotary polishing machine, and subjected to scorching treatment at 500° C. to obtain a disk brake pad. In the disk brake pads obtained in the Examples and the Comparative Examples, the thickness of the back metal was 6 mm, the thickness of the overlay material was 9 mm, the thickness of the underlay material was 2 mm, and the projected area of the friction material was 52 cm².

Measurement and evaluation were performed according to the methods using the obtained disk brake pad. The results are shown in Table 2.

TABLE 1
Friction material composition for overlay material

| | | | |
|---|---|---|---|
| Content | Bonding material | Phenolic resin | 10 |
| (parts | Organic fillers | Cashew particles | 5 |
| by mass) | | Pulverized powder of tire | 5 |
| | | tread rubber | |
| | Inorganic Fillers | Potassium titanate | 20 |
| | | Zirconia | 10 |
| | | Mica | 5 |
| | | Graphite | 5 |
| | | Tin sulfide | 5 |
| | | Barium sulfate | 23.5 |
| | | Calcium hydroxide | 1.5 |
| | Fiber Substrates | Aramid fibers | 5 |
| | | Artificial mineral fibers | 5 |

TABLE 2

| | | | Examples | | | | Comparative Examples | | | | |
|---|---|---|---|---|---|---|---|---|---|---|---|
| Friction material composition for underlay material | | | 1 | 2 | 3 | 4 | 1 | 2 | 3 | 4 | 5 |
| Content | Bonding material | Phenolic resin | 10 | 10 | 10 | 10 | 10 | 10 | 20 | — | 10 |
| (parts by | Organic fillers | Cashew particles | 3 | 3 | 3 | 3 | 3 | 3 | 3 | — | 3 |
| mass) | | Pulverized powder of | 3 | 3 | 3 | 3 | 3 | 3 | 3 | — | 3 |
| | | tire tread rubber | | | | | | | | | |
| | Inorganic Fillers | Graphite | 6 | 6 | 6 | 6 | 6 | 6 | 6 | — | 6 |
| | | Barium sulfate | 51 | 43 | 51 | 43 | 43 | 51 | 48 | — | 51 |
| | | Calcium hydroxide | 2 | 2 | 2 | 2 | 2 | 2 | 2 | — | 2 |
| | Fiber Substrates | Aramid fibers | 3 | 3 | 3 | 3 | 3 | 3 | 3 | — | 3 |
| | | Artificial mineral fibers | 15 | 15 | 15 | 15 | 15 | 15 | 15 | — | 15 |
| | | Glass fibers | 2 | 10 | 2 | 0 | 10 | 2 | 0 | — | 2 |
| | | Fibrous wollastonite A | 5 | 5 | 0 | 15 | 0 | 0 | 0 | — | 5 |
| | | Fibrous wollastonite B | 0 | 0 | 5 | 0 | 0 | 0 | 0 | — | 0 |
| | | Fibrous wollastonite C | 0 | 0 | 0 | 0 | 5 | 0 | 0 | — | 0 |
| | | Fibrous wollastonite D | 0 | 0 | 0 | 0 | 0 | 5 | 0 | — | 0 |

| Thickness of friction | Overlay material | | 9 | 9 | 9 | 9 | | 9 | 9 | 11 | — |
|---|---|---|---|---|---|---|---|---|---|---|---|
| material (mm) | Underlay material | | 2 | 2 | 2 | 2 | | 2 | 2 | — | 11 |
| Measurement and | (1) Presence or Absence of | | Absent | Absent | Absent | Absent | Present | Absent | Absent | Absent | Absent |
| evaluation results | Aggregate | | | | | | | | | | |
| | (2) Compression strain (μm) | | 182 | 185 | 183 | 180 | — | 182 | 162 | 187 | 173 |
| | (3) Shear strength | 20° C. | 42 | 47 | 41 | 40 | — | 36 | 44 | 31 | 43 |
| | (kN) | 300° C. | 27 | 30 | 26 | 27 | — | 22 | 27 | 22 | 28 |

| | | | | | | | | | |
|---|---|---|---|---|---|---|---|---|---|
| (4) Crack resistance | A | A | A | A | — | B | A | B | A |
| (5) Disk rotor-attacking | 5 | 6 | 4 | 5 | — | 4 | 5 | 5 | 12 |
| properties (μm) | | | | | | | | | |

In the Examples, compared with the Comparative Examples, the vibration damping properties are at the same or higher level (the compression strain is large), and the shear strength at normal temperature and high temperature is high, the crack resistance is excellent, and the disk rotor-attacking properties are also reduced. Particularly, from the comparison between the Examples and Comparative Examples 4 to 5, it is found that by providing a friction material of two-layer structure using an overlay material and an underlay material in combination, the shear strength, the crack resistance, and the disk rotor-attacking properties are excellent, compared with the case of a friction material of one-layer structure having no underlay material. When a friction material of one-layer structure was provided without providing an underlay material, as in Comparative Example 4, the shear strength and the crack resistance decreased. When a friction material comprising only the same friction material composition for an underlay material as the one used in Example 1 was provided as in Comparative Example 5 (in other words, when, in a friction material-back metal configuration, the friction material was a friction material of one-layer structure comprising only an underlay material, and the friction material-back metal corresponded to underlay material-back metal), the shear strength and the crack resistance were good, but the problem of an increase in disk rotor-attacking properties occurred. From the results of the Comparative Example 5, it is found that the object to be achieved by the present invention cannot be achieved even with the particular fibrous wollastonite used in the present invention when it is used in a friction material having an underlay material-back metal configuration.

It can be said that the friction material compositions for underlay materials used in the above Examples contain no copper or iron-based metal (for example, copper fibers or iron fibers) and therefore form friction materials and friction members having low environmental harmfulness and a high rust suppression effect.

### INDUSTRIAL APPLICABILITY

The friction member of the present invention is preferred particularly as an automobile friction member because its underlay material has high vibration damping properties (large compression strain) and can satisfy all of shear strength at normal temperature and high temperature, crack resistance, and further a reduction in disk rotor-attacking properties.

### REFERENCE SIGNS LIST

1 overlay material
2 underlay material
3 back metal
4 shim
5 friction material
6 friction member

1. A friction member comprising an overlay material, an underlay material, and a back metal in this order,
wherein the underlay material comprises fibrous wollastonite, an average fiber length of the fibrous wollastonite is 100 to 850 μm, and an aspect ratio (average fiber length/average fiber diameter) of the fibrous wollastonite is 8 or more.

2. The friction member according to claim 1, wherein the aspect ratio (average fiber length/average fiber diameter) of the fibrous wollastonite is 8 to 20.

3. The friction member according to claim 1, wherein the underlay material further comprises at least one selected from the group consisting of an organic filler, an inorganic filler, organic fibers, and a bonding material.

4. The friction member according to claim 1, wherein the underlay material further comprises inorganic fibers other than the fibrous wollastonite.

5. The friction member according to claim 4, wherein the inorganic fibers are at least one selected from the group consisting of glass fibers, metal fibers, artificial mineral fibers, carbon fibers, ceramic fibers, biodegradable ceramic fibers, sepiolite, attapulgite, potassium titanate fibers, silica alumina fibers, and flame-resistant fibers.

6. A friction material composition for an underlay material, the friction material comprising fibrous wollastonite, wherein an average fiber length of the fibrous wollastonite is 100 to 850 μm, and an aspect ratio (average fiber length/average fiber diameter) of the fibrous wollastonite is 8 or more.

7. The friction material composition for an underlay material according to claim 6, wherein the aspect ratio (average fiber length/average fiber diameter) of the fibrous wollastonite is 8 to 20.

8. The friction material composition for an underlay material according to claim 6, further comprising at least one selected from the group consisting of an organic filler, an inorganic filler, organic fibers, and a bonding material.

9. The friction material composition for an underlay material according to claim 6, further comprising inorganic fibers other than the fibrous wollastonite.

10. The friction material composition for an underlay material according to claim 9, wherein the inorganic fibers are at least one selected from the group consisting of glass fibers, metal fibers, artificial mineral fibers, carbon fibers, ceramic fibers, biodegradable ceramic fibers, sepiolite, attapulgite, potassium titanate fibers, silica alumina fibers, and flame-resistant fibers.

11. A friction material comprising an underlay material obtained by molding the friction material composition for an underlay material according to claim 6.
